(19) United States
(12) Patent Application Publication
(10) Pub. No.: US 2007/0031060 A1
(43) Pub. Date: Feb. 8, 2007

(54) IMAGE PROCESSING APPARATUS, METHOD FOR CALCULATING WHITE BALANCE EVALUATION VALUE, PROGRAM INCLUDING PROGRAM CODE FOR REALIZING THE METHOD FOR CALCULATING WHITE BALANCE EVALUATION VALUE, AND STORAGE MEDIUM FOR STORING THE PROGRAM

(75) Inventor: Masao Okada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/456,317

(22) Filed: Jul. 10, 2006

(30) Foreign Application Priority Data
Aug. 4, 2005 (JP) 2005-226625

(51) Int. Cl. G06K 9/40; G06K 9/46; G06K 9/00

(52) U.S. Cl. 382/274; 382/190; 382/167

(57) ABSTRACT

A method and apparatus for calculating a white balance evaluation value, includes detecting a face area from image data, extracting from the image data, for each detected face area, a body candidate area where the body is presumed to exist, and calculating a white balance evaluation value based on a detection result of the face area and an extraction result of the body candidate area.

### BACKGROUND OF THE INVENTION

1. Field of the Invention

The present invention relates to a method for controlling white balance when a face is detected in an imaging apparatus that performs an image process on input image data and outputs the processed data.

2. Description of the Related Art

In imaging apparatuses, such as a digital camera and a digital video camera, in order to achieve color balance of image data, white balance (hereafter referred to as WB) is adjusted, as described below.

An analog signal, which has passed through color filters and is outputted from an imaging device, is converted into a digital signal by an analog/digital (A/D hereafter referred to as A/D) converter, and then split into blocks as shown in FIG. 3A.

Each block is formed by each one of color signals, R (red), G1 (green), G2 (green), and B (blue) as shown in FIG. 3B.

For each block, color evaluation values are calculated by following equations.
Cx={(R+G2)−(B+G1)}/Y
Cy={(R+B)/4−(G1−G2)/4}/Y
Y=(R+G1+G2+B)/4

where Y is a luminance signal.

FIG. 4 is a diagram showing a white detection range which changes according to color temperature. FIG. 4 also shows a color coordinate system, in which as a longitudinal axis, Cx=(R−B)/Y and as a lateral axis, Cy=(R+B)/4Y. The color coordinate system shows a white axis determined by taking picture of white color at high color temperatures to low color temperatures and indicating color evaluation values Cx and Cy on the coordinate system. Since there is some variation in white color in an actual light source, a somewhat extended range with the white axis as its center is designated as a white detection range (a range which should be determined to be white). In other words, the color evaluation values Cx and Cy obtained for each block are shown on the coordinate system.

The blocks that have color evaluation values included in the white detection range are presumed to be white. Further, by calculating integration values SumR, SumG1, SumG2, and SumB of color pixels in the white detection range, and by using the following equations, a WB coefficient is obtained.

In the equations, kWB₁₃ R, kWB₁₃ G1, kWB₁₃ G2, and kWB₁₃ B are WB coefficients of color signals R, G1, G2, and B respectively.
kWB_{—}R=1.0/SumR
kWB_{—}G1=1.0/SumG1
kWB_{—}G2=1.0/SumG2
kWB_{—}B=1.0/SumB

However, the above-described calculation of WB coefficients has a shortcoming. At a high color temperature, color evaluation values of white color are distributed in the vicinity of range A of FIG. 4.

However, if color evaluation values Cx and Cy of a human skin under a high color temperature light source are expressed in a coordinate system, those values are distributed on the low color temperature side in the white detection range.

Accordingly, in a screen image in which there is little white color, and the human skin is closed-up, the color evaluation values of the screen image will be distributed in the area B of FIG. 4.

That is, there is a problem in that the human skin is erroneously determined white at a low color temperature, and the human skin is represented as white.

Japanese Patent Application Laid-Open No. 2003-189325 discusses a technology related to WB control in an imaging apparatus capable of detecting a face. According to this technology, when a face is recognized in a face recognition mode, an area for acquiring WB evaluation value is moved away from a face portion to prevent WB of the face portion from being calculated.

More specifically, when a picture of a human figure is taken using the above-mentioned technology, since a color of the person's face is very close to a hue of color obtained, if an achromatic color area is illuminated by a light of a low color temperature light source, the color of the face is misrecognized and the face is represented in white. This problem can be solved by the foregoing technology.

However, according to the above technology, only the area of the face portion is excluded from the WB evaluation value acquiring area. Therefore, for example, in a case of a human figure taken as an object which has wide portions of exposed bare skin other than the face, such as a person in a bathing suit, the WB evaluation value is influenced by the skin color of bare portions of the person's body. For this reason, there is a problem in that WB control cannot be performed correctly.

### SUMMARY OF THE INVENTION

The present invention has been made in consideration of the above situation, and is directed to a WB process performed with high accuracy by switching over areas where WB evaluation values are acquired, depending on different scenes.

According to an aspect of the present invention, an image processing apparatus includes a face detecting unit configured to detect a face area from image data; an area extracting unit configured to extract from the image data, for each detected face area, a body candidate area where a body is presumed to exist; and a calculating unit configured to calculate a white balance evaluation value based on a detection result by the face detection unit and an extraction result by the area extracting unit.

According to another aspect of the present invention, a method of calculating a white balance evaluation value of image data includes detecting a face area from image data; extracting from the image data, for each detected face area, a body candidate area where a body is presumed to exist; and calculating a white balance evaluation value based on a detection result of the face area and an extraction result of the body candidate area.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flowchart showing a WB process of an imaging apparatus according to a first embodiment of the present invention.

FIG. 2 is a diagram showing a schematic structure of the imaging apparatus of the present invention.

FIGS. 3A and 3B are diagrams showing WB evaluation value detection blocks.

FIG. 4 is a diagram showing a white detection range which changes with color temperature.

FIGS. 5A and 5B are diagrams showing areas for acquiring WB evaluation values.

FIG. 6 is a flowchart showing a WB process of an imaging apparatus according to a second embodiment of the present invention.

FIG. 7 is a diagram showing a concrete example of assigning weights to areas for acquiring WB evaluation values.

FIG. 8 is a flowchart showing a WB process of an imaging apparatus according to a third embodiment of the present invention.

### DETAILED DESCRIPTION OF THE EMBODIMENTS

Exemplary embodiments of the present invention will be described in detail below in accordance with the accompanying drawings.

### First Embodiment

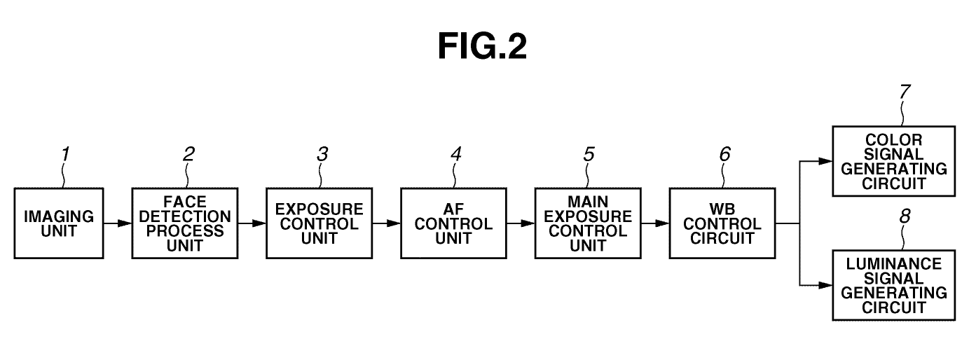

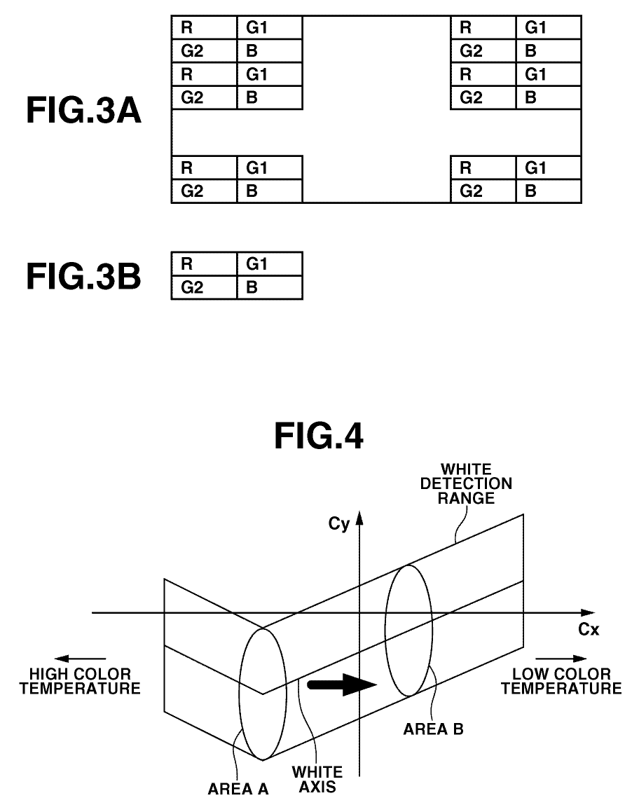

FIG. 2 is a block diagram of an imaging apparatus that has a face detecting function. In FIG. 2, an imaging unit 1 includes an imaging device, where the image device includes a lens system, a diaphragm, a shutter, a photoelectric conversion function, such as CCD, and an A/D converter. The imaging device outputs, as a digital signal, an image projected by the lens system to a face detection process unit 2.

The face detection process unit 2 determines whether there is a human face in image data output from the imaging unit 1 by using a well-known face detecting method. If a face is present, the face detection process unit 2 detects a face area.

Typical face detecting methods include using learning represented by a neural network and searching image portions having characteristic features, like an eye, a nose, and a mouth by using template matching, and recognizing the object as a face if detected features have a high degree of similarity to an eye, a nose, or the like.

A number of other methods have been proposed, including detecting amounts of a characteristic image, such as a skin color or an eye shape and using statistical analysis. In many instances, some of these known methods are combined.

Japanese Patent Application Laid-Open No. 2002-251380 discusses a face detection method which uses wavelet conversion and amounts of the characteristic image.

An exposure control unit 3 controls exposure-related settings, such as the diaphragm and the shutter, based on information obtained in the face detection process unit 2. An auto-focus (hereafter referred to as AF) control unit 4 specifies a focused point in the face detecting area based on information from the face detection process unit 2. A main exposure control unit 5 controls the diaphragm and the mechanical shutter set at the exposure control unit 3. Though the exposure control unit 3 and the main exposure control unit 5 are typically combined as a single unit, they are depicted in FIG. 2 as separate units for ease of understanding the flow of an imaging process.

A WB control unit 6 performs a WB process on image data captured in main exposure. The WB control circuit 6 is capable of saturation adjustment and edge enhancement. A color signal generating circuit 7 generates color difference signals U and V from data which was subjected to the WB process in the WB control circuit 6. A luminance signal generating circuit 8 generates a luminance signal Y from data which was subjected to the WB process in the WB control circuit 6.

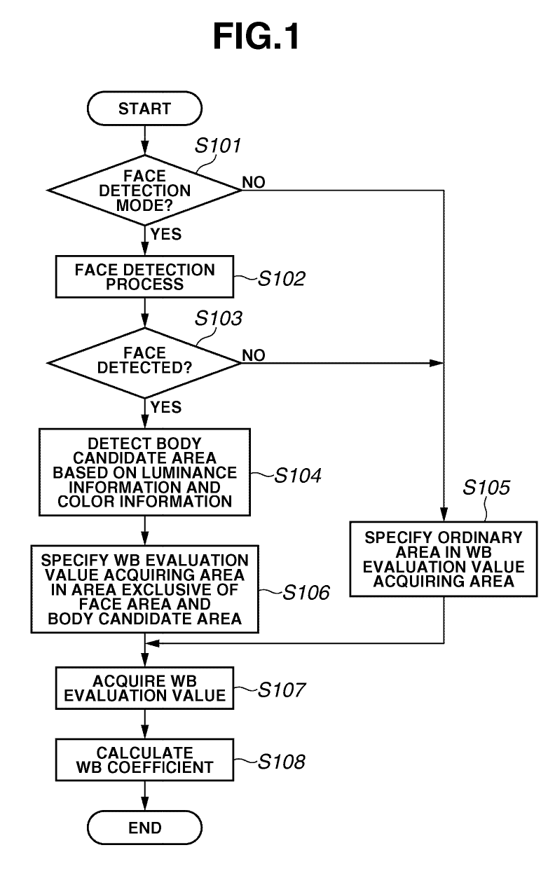

Next, referring to the flowchart in FIG. 1, the operations and process in the imaging apparatus according to a first embodiment of the present invention is described.

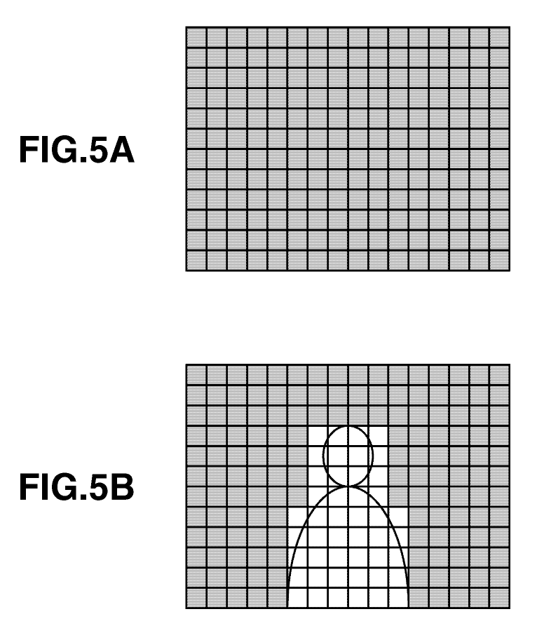

FIGS. 5A and 5B are diagrams showing the WB evaluation value acquiring areas when a face is detected in a face detection mode. FIG. 5A is a diagram showing a case where the whole image screen is used as the WB evaluation value acquiring area. FIG. 5B is a diagram showing that the areas which have approximately the same luminance information and color information as the face area are excluded as object areas from the WB evaluation value acquiring area. For example, a human figure whose upper body is naked.

Turning back to FIG. 1, when the power supply for the imaging apparatus is turned on, the imaging apparatus prepares for an imaging operation.

First, in step S101, a central processing unit (CPU) (not shown) of the imaging apparatus determines whether the imaging apparatus is set in the face detection mode.

When the CPU determines that the imaging apparatus is in the face detection mode, the process proceeds to step S102, where the face detection process unit 2 performs face detection on image data obtained from the imaging device (i.e., imaging unit 1).

If the CPU determines that the imaging apparatus is not in the face detection mode, the process proceeds to step S105, where an ordinary area in the WB evaluation value acquiring area is set (e.g., the shaded portion in FIG. 5A is set to be an area (whole image screen) for acquiring a WB evaluation value).

Next, in step S103, the CPU determines whether a face is detected in the face detection process unit 2. If the CPU determines that no face was detected, the process proceeds to step S105. If, the CPU determines that a face is detected in the face detection process unit 2, the process proceeds to step S104.

In step S104, the CPU detects an area where the values of luminance information and color information are respectively within predetermined ranges of the values of the face area. The CPU designates that area as a body candidate area, which is a part of the body as an image object. The predetermined ranges are obtained statistically as a result of a number of actual comparisons between the face area and the bare skin area of the body.

If a plurality of faces are detected in step S102, all areas where the values of luminance information and color information are within predetermined ranges of the values of each face are detected as body candidate areas. In other words, if a plurality of faces are detected, all body candidate areas based on luminance information and color information of respective faces are detected.

In step S106, a WB evaluation value acquiring area in an area exclusive of the face area and the body candidate area is specified. For example, the shaded portion of FIG. 5B depicts the area excluding the face area and the body candidate area. As described above, FIG. 5B is an example showing a human figure whose upper body is naked. If, for example, the upper body is covered with a short sleeve shirt, the area of the person's bare forearm below the elbow is detected as a body candidate area.

Next, in step S107, the CPU obtains a WB evaluation value from a WB evaluation value acquiring area specified in either step S105 or step S106.

In step S108, according to a result of the process in step S107, the CPU calculates a final WB coefficient.

In the first embodiment of the present invention, as a body candidate area, an area is extracted that has luminance information and color information the values of which are in predetermined ranges of the values of the face area. However, the present invention is not limited to this area. For example, either one of the values of luminance information and color information may be extracted which is in a specified range of the value of the face range.

When a body candidate area is detected, by limiting detection targets only to a neighborhood area of the detected face area, time required for detection can be shortened. Further, when the face detection mode is not selected, or when any face area is not detected in the face detection mode, a WB evaluation value acquiring area is set in an ordinary area, and thereby unnecessary processes can be omitted.

It is possible to prepare WB coefficient tables from which one can choose a WB coefficient that optimizes the skin color of the detected face area.

As has been described, according to the first embodiment, when a face is detected, a face area and a body candidate area are detected where the values of luminance information and color information are in predetermined ranges of the values of the face area, and those areas are excluded from the area for acquiring a WB evaluation value.

By employing the method according to the first embodiment, even when there is a large area of bare skin other than the face, such as an object wearing a bathing suit, the skin color is not misrecognized as white color at a low color temperature, and thus a WB process can be performed with high accuracy.

### Second Embodiment

In the first embodiment, an area is detected as a body candidate area where the values of luminance information and color information are within predetermined ranges with respect to the values of the face area, and the face area and the body candidate area are excluded from the WB evaluation value acquiring area. In contrast, in a second embodiment a WB evaluation value is calculated by assigning smaller weights to the face area and the body candidate area than to other areas.

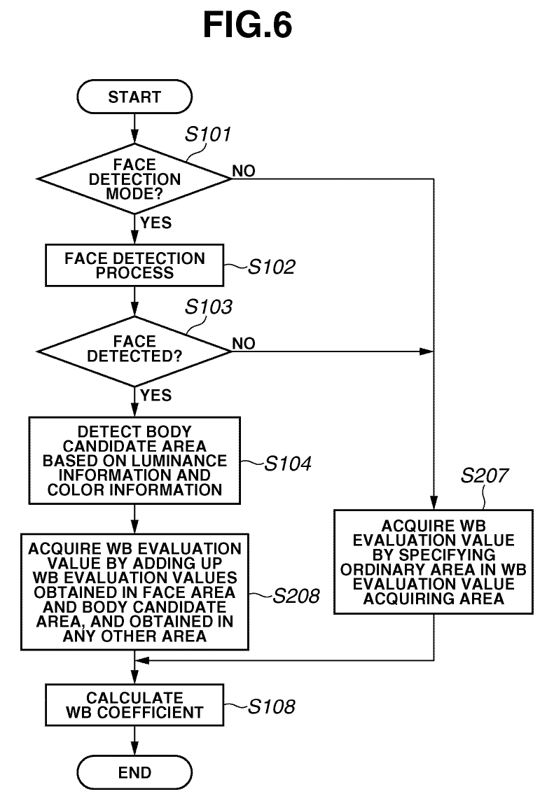

FIG. 6 is a flowchart of an imaging process in the second embodiment. Steps S101 to S104, and step S108 are the same as in FIG. 1, and as such, their descriptions are not repeated herein.

If, in step S101, the CPU determines that the imaging apparatus is not in the face detection mode, or if the CPU determines that a face is not detected by the face detection process unit 2 in step S103, the process proceeds to step S207.

In step S207, the CPU designates the entire image as a WB evaluation value acquiring area, and obtains a WB evaluation value. Then, the process proceeds to step S108.

If, in step S101, the CPU determines that the imaging apparatus is in the face detection mode and if in step S103 a face is detected by the face detection process unit 2, flow proceeds to step S104, where the CPU detects a body candidate area which has luminance information and color information whose value is within a predetermined range of the value of the face area.

Next, in step S208, the CPU assigns a weight to a WB evaluation value obtained from the face area and the body candidate area, and to a WB evaluation value obtained from the other area, and acquires a WB evaluation value for the whole image.

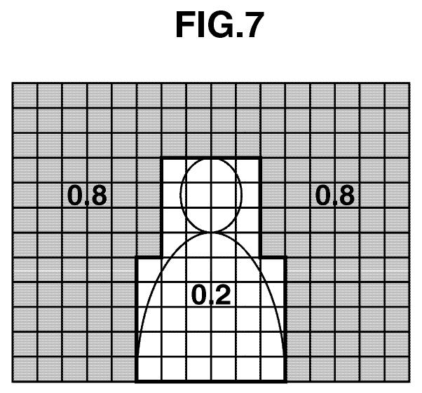

FIG. 7 shows an example of weights assigned to the WB evaluation value acquiring area in step S208. In step S208, weights are assigned to WB evaluation values so as to achieve a ratio of 1:4 between a WB evaluation value obtained from the face area and the body candidate area, and a WB evaluation value obtained from an area other than the face area and the body candidate area. More specifically, a WB evaluation value obtained from the face area and the body candidate area is multiplied by a coefficient, 0.2, and a WB evaluation value obtained from the other area is multiplied by a coefficient, 0.8. Two products are put together to obtain a sum.

By assigning weights to the values, WB evaluation values obtained from the face area and the body candidate area are taken into account though the weights are small. Therefore, even if misrecognition of a face occurs when detecting a face, effects on WB control can be reduced.

In the second embodiment, by assigning a small ratio of weight to a WB evaluation value obtained from the face area and the body candidate area, a WB evaluation value cannot be influenced by the skin color of the object which may hinder accurate WB control.

### Third Embodiment

A third embodiment of the present invention differs from the first embodiment in that an area approximately the same distance as the face area is treated as a body candidate area and is excluded from an area used for calculation to obtain a WB evaluation value.

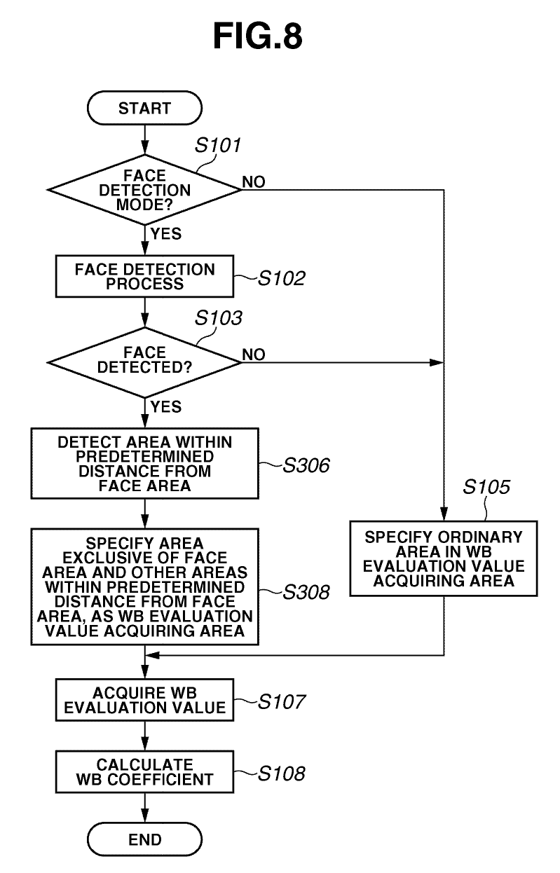

FIG. 8 is a flowchart of an imaging process in a third embodiment of the present invention. In FIG. 8, steps S101 to S103, S105, and S107 to S108 are the same as those described in the first embodiment, and as such, their descriptions are not repeated herein.

In step 306, the CPU detects an area located at a distance within a predetermined range of the face area, and then the process proceeds to step S308. The predetermined range referred to here is a range of values statistically obtained from results of multiple comparisons between distance information of the face area and distance information of the hands and legs or the trunk areas. It is also possible to change the size of the predetermined range according to the size of the detected face area.

If a plurality of faces are detected in step S102, all areas are detected where the value of distance information is in a predetermined range of each face area. In other words, if a plurality of faces are detected, all body candidate areas based on distance information of individual face areas are detected.

In step S308, the CPU specifies, as a WB evaluation value acquiring area, an area other than the face area detected in the processes up to step S306 and other than an area within a predetermined range of distance from the face area. Then, the process proceeds to step S107.

When an area within a predetermined range of distance from the face area is detected, as a target for detecting a body candidate area, only a neighborhood area within a predetermined range of the detected face area is specified as a reference position. Thus, the detection process speed can be increased.

As described above, according to the third embodiment, typically the whole image shows a WB evaluation value acquiring area. However, if a face is detected, a body candidate area is detected where the value of its distance information is within a predetermined range from the face area, and the face area and the body candidate area are excluded from the WB evaluation value acquiring area.

Consequently, for example, even when the image is taken in a backlit scene and it is difficult to obtain luminance information and color information correctly, the object is detected with high accuracy and is excluded from a WB evaluation value acquiring area, and thus a WB process can be correctly executed.

In order for various devices to realize the functions of the above-described embodiments, a program code of software to realize the functions of the embodiments can be supplied to the computer in the equipment or the system connected to the devices.

Configurations in which the devices are operated by programs stored in the computer (CPU or MPU) are included in the scope of the present invention.

The program code itself and a method for supplying the program to the computer, such as storage medium storing the program code, are included in the scope of the present invention.

As the storage medium for storing program codes, a floppy disk, a hard disk, an optical disk, a magneto-optical disk, a CD-ROM, a magnetic tape, a nonvolatile memory card, or a ROM may be used.

The present invention is not limited to realization of the functions of the above-described embodiments where the computer executes a supplied program code. For example, when the functions of embodiments are realized jointly by the program code and an operating system (OS) or some application soft running on the computer.

In addition, the supplied program code can be stored in memory in a function extension board in a computer or in a functional extension unit connected to a computer.

The CPU included in the functional extension board or unit executes a part of or all of the process according to an instruction from the program code, and thus the functions of the above-described embodiments are implemented. This case is also included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2005-226625 filed Aug. 4, 2005, which is hereby incorporated by reference herein in its entirety.

What is claimed is:

1. An image processing apparatus including:
a face detecting unit configured to detect a face area from image data;
an area extracting unit configured to extract from the image data, for each detected face area, a body candidate area where a body is presumed to exist; and
a calculating unit configured to calculate a white balance evaluation value based on a detection result by the face detection unit and an extraction result by the area extracting unit.

2. The image processing apparatus according to claim 1, wherein the area extracting unit extracts the body candidate area by using color information obtained from the face area.

3. The image processing apparatus according to claim 1, wherein the area extracting unit extracts the body candidate area by using luminance information obtained from the face area.

4. The image processing apparatus according to claim 1, wherein the area extracting unit extracts the body candidate area by using distance information obtained from the face area.

5. The image processing apparatus according to claim 1, wherein the calculating unit calculates a white balance evaluation value by using an area excluding the face area and the body candidate area from the image data.

6. The image processing apparatus according to claim 1, wherein the calculating unit calculates a white balance evaluation value by assigning a larger weight to the area excluding the face area and the body candidate area from the image data than weights assigned to the face area and the body candidate area.

7. The image processing apparatus according to claim 1, wherein, if the face detecting unit detects a plurality of faces, the area detecting unit extracts a body candidate area for each of the faces detected from the image data.

8. The image processing apparatus according to claim 1, further comprising an imaging device having a photoelectric conversion function, wherein the calculating unit calculates a white balance evaluation value based on image data obtained by the imaging device.

9. A method of calculating a white balance evaluation value of image data, comprising:
detecting a face area from image data;
extracting from the image data, for each detected face area, a body candidate area where a body is presumed to exist; and
calculating a white balance evaluation value based on a detection result of the face area and an extraction result of the body candidate area.

10. The method for calculating a white balance evaluation value according to claim 9, wherein the body candidate area is extracted by using color information obtained from the face area.

11. The method for calculating a white balance evaluation value according to claim 9, wherein the body candidate area is extracted by using luminance information obtained from the face area.

12. The method for calculating a white balance evaluation value according to claim 9, wherein the body candidate area is extracted by using distance information obtained from the face area.

13. Computer-executable process steps for realizing the method for calculating a white balance evaluation code in claim 9.

14. A computer-readable storage medium, storing the computer-executable process steps of claim 13.
